(19) United States
(12) Patent Application Publication
(10) Pub. No.: US 2024/0181572 A1
(43) Pub. Date: Jun. 6, 2024

(54) DRY METHOD FOR METAL-DEFINED PAD FORMATION

(71) Applicant: Intel Corporation, Santa Clara, CA (US)

(72) Inventors: Tchefor NDUKUM, Chandler, AZ (US); Deniz TURAN, Chandler, AZ (US); Yonggang LI, Chandler, AZ (US)

(21) Appl. No.: 18/060,578

(22) Filed: Dec. 1, 2022

(51) Int. Cl. B23K 26/40; B23K 26/0622; B23K 26/082

(52) U.S. Cl. CPC B23K 26/40; B23K 26/0622; B23K 26/082; B23K 2101/40

(57) ABSTRACT

The present disclosure generally relates to a method. The method may include providing a substrate and forming a seed layer on the substrate. The method may further include forming a first metal layer on selected portions of the seed layer to form exposed portions of the seed layer. The method may also include scanning a laser beam across the substrate to remove the exposed portions of the seed layer to form exposed portions of the substrate.

### BACKGROUND

Advanced substrate packages with either organic or glass cores need to perform at higher and higher frequencies with increasing load. The insertion loss (IL), on the other hand, needs to continue to reduce in order to meet the requirements needed for enabling next generation products. While low loss materials are important and needed to reduce the loss, a large component of the overall IL comes from the socket area. Reducing the socket area by reducing the land grid array (LGA) pad size may significantly reduce the capacitance build-up and hence, may reduce the IL. This can be achieved by using Metal-Defined (MD) pads, instead of traditional Solder-Metal-Defined (SMD) pads.

One key step of MD pad formation involves stripping minute traces of the metal seed. Current approach uses wet chemistry, particularly potassium cyanide (KCN), which is environmentally unfriendly, limited in scaling and high-cost solution. This wet chemistry process also has issues with surface finish (SF) metal footing and stray plating (e.g., SF metal particles) on the substrate surface. These limitations are primarily due to limited mass transfer of the wet chemistry flow.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the present disclosure. The dimensions of the various features or elements may be arbitrarily expanded or reduced for clarity. In the following description, various aspects of the present disclosure are described with reference to the following drawings, in which:

FIGS. 1A through 1D show cross-sectional views directed to an exemplary simplified process flow for forming an assembly 100 including metal-defined pads according to an aspect of the present disclosure;

FIG. 2 shows a top down SEM image of a metal-defined pad after a surface finish process step according to an aspect of the present disclosure;

FIG. 3 shows a top down SEM image of a dielectric substrate surface after the surface finish process step according to an aspect of the present disclosure; and

FIG. 4 shows a flow chart illustrating a method for forming an assembly according to an aspect of the present disclosure.

### DETAILED DESCRIPTION

The following detailed description refers to the accompanying drawings that show, by way of illustration, specific details and aspects in which the present disclosure may be practiced. These aspects are described in sufficient detail to enable those skilled in the art to practice the present disclosure. Various aspects are provided for devices, and various aspects are provided for methods. It will be understood that the basic properties of the devices also hold for the methods and vice versa. Other aspects may be utilized and structural, and logical changes may be made without departing from the scope of the present disclosure. The various aspects are not necessarily mutually exclusive, as some aspects may be combined with one or more other aspects to form new aspects.

Present disclosure may attempt to address the wet chemistry issues by using a laser beam, e.g., a low dose excimer laser beam, to strip remaining seed layer on a substrate. This approach is scalable and provides significant runrate improvement opportunities, and may lead to better performance with no stray plating (i.e., no surface finish metal particles on the dielectric substrate and on the solder resist) and little or no surface metal foot seen on the metal-defined pads. In addition, no e-less tails are expected. E-less tail remaining is typical for wet processing (with KCN). Excimer laser scanning at low fluence is a dry process and will not cause an e-less tail. FIB XSEM plus EDS study may detect the e-less layer and confirm no e-less tail.

The present disclosure generally relates to a method. The method may include providing a substrate and forming a seed layer on the substrate. The method may further include forming a first metal layer on selected portions of the seed layer to form exposed portions of the seed layer. The method may also include scanning a laser beam across the substrate to remove the exposed portions of the seed layer to form exposed portions of the substrate.

In various aspects, the method may include scanning a laser beam using an excimer laser or a ultraviolet laser. Other laser systems may also be used, for example, infrared (IR) or near-infrared (NIR) lasers. Depending on the type of laser system employed, a cleaning process may be needed afterwards.

In various aspects, the method may include scanning a laser beam using an excimer laser. For example, a low dose laser beam may be used for the scanning.

The present disclosure also generally relates to an assembly. The assembly may include a substrate and a seed layer on the substrate. The assembly may also include a first metal layer on selected portions of the seed layer to define exposed portions of the seed layer, wherein the assembly may include exposed portions of the substrate.

To more readily understand and put into practical effect the present disclosure, particular aspects will now be described by way of examples and not limitations, and with reference to the drawings. For the sake of brevity, duplicate descriptions of features and properties may be omitted.

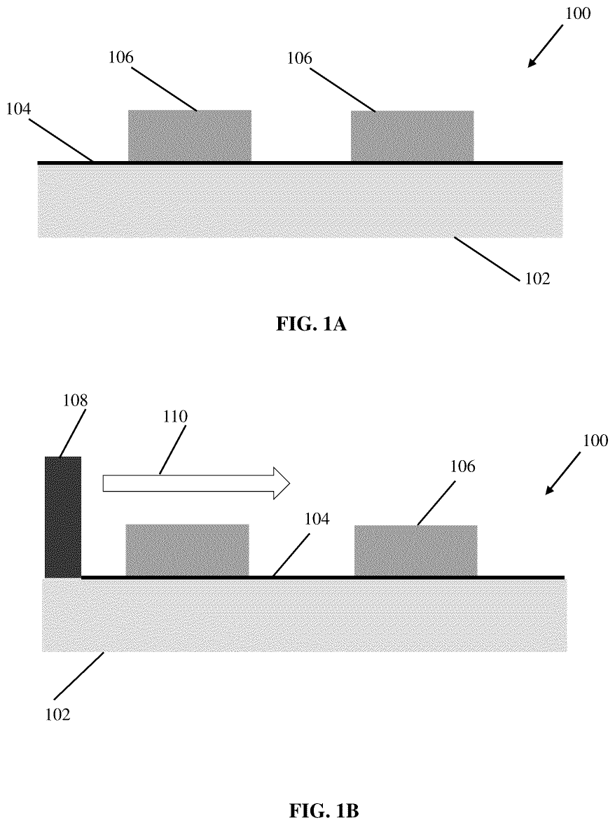

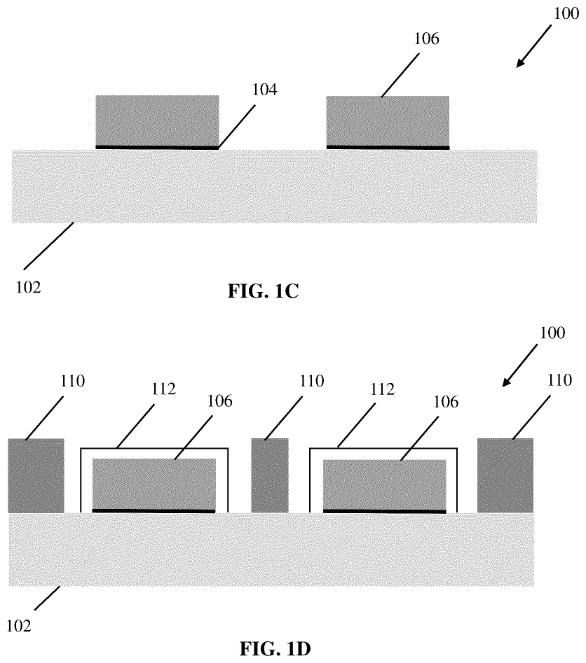

FIGS. 1A through 1D show cross-sectional views directed to an exemplary simplified process flow for forming an assembly 100 including metal-defined pads according to an aspect of the present disclosure.

FIG. 1A shows the assembly 100, e.g., an electronic assembly. The electronic assembly 100 may form part of a semiconductor package. The assembly 100 may include a substrate 102. The substrate 102 may include an insulating or a dielectric material. In one aspect, the substrate may include an Ajinomoto Build-up Film (ABF). In other aspects, any dielectric film may also be used, e.g., a solder resist film.

Various components or materials may subsequently be formed on the substrate 102. In various aspects, a seed layer 104 may be formed on a top surface of the substrate 102. The seed layer 104 may be formed as a continuous layer on the substrate 102. The seed layer 104 may be formed by convention techniques such as plating, sputtering, electroplating, chemical vapor deposition (CVD), atomic layer deposition (ALD), or evaporation. The seed layer 104 may include a metal such as palladium (Pd). Other suitable seed metals may include titanium copper (TiCu), nickel chromium (NiCr), copper (Cu), or chromium (Cr).

In various aspects, a first metal layer 106 may be formed on the seed layer 104. The seed layer 104 may serve to facilitate or enable the formation or deposition of the first metal layer 106. The first metal layer 106 may be formed by convention techniques such as sputtering, electroplating, CVD, or atomic layer deposition. The first metal layer 106 may include a metal such as copper (Cu).

In the aspect shown in FIG. 1A, the first metal layer 106 may be formed on selected portions of the seed layer 104 to form exposed portions of the seed layer 104. In other words, a patterned metal layer 106 may be formed on the seed layer 104 and portions of the seed layer 104 on which the patterned metal layer 106 is formed may be called the un-exposed portions of the seed layer 104.

Next step may involve removal of the exposed or remaining portions of the seed layer 104. As mentioned in above paragraphs, a flash etch wet chemistry is currently being adopted in the industry to remove the exposed portions of the seed layer 104. One disadvantage associated with the use of such wet chemistry is that the flash etch step typically leaves behind a very thin layer of unwanted seed. The remaining seed, if not removed, may further act as a seed layer later in the process flow and may cause unwanted plating during the metal-defined pad formation.

FIG. 1B shows a dry process to strip or remove the seed layer 104 remaining on the substrate 102. This dry approach is cheaper (with TCoO improvement opportunities), environmentally friendly and opens up the possibility of creating and scaling metal-defined pads of any shape as needed for next generation products.

In the aspect shown in FIG. 1B, a laser beam 108 may be provided. The laser beam 108 may be scanned across the substrate 102 in a direction shown by the arrow 110. In other words, the substrate 102, the seed layer 104, and/or the first metal layer 106 may be exposed to the laser beam 108 during the scanning. Any suitable laser system with an efficient beam delivery may be used in the scanning step. In various aspects, a UV laser or an excimer laser may be used for the scanning to remove the seed layer 104 remaining on the substrate 102.

In various aspects, a low dose of the excimer laser 108 may be used for the scanning. In the present context, by the term “low dose” is meant a low fluence and/or a low pulse count. For example, a low dose excimer laser including 1 J/cm² or less, such as 0.3 J/cm² to 0.8 J/cm² fluence and/or 10 or less pulse per second, such as, 1 to 4 pulse per second may be used.

As mentioned above, other laser systems with efficient beam delivery may also be used. Some amount of cleaning or desmearing might be needed for laser systems that leave smear after the scan.

An advantage of using a low dose laser beam may be the thin seed layer 104 can be removed by simply scanning the laser beam 108 across the substrate 102. The laser beam 108 may create a shock wave in the substrate 102 that may strip and lift off the thin seed layer 104.

FIG. 1C shows the assembly 100 after the scanning step. As shown in this figure, the seed layer 104 of previously exposed portions may be stripped from the substrate 102, thereby leaving the respective underlying portions of the substrate 102 now exposed.

After stripping the seed layer 104, conventional back-end (BE) processes including BE lithography may be carried out to laminate, cure and pattern solder resist (SR) dielectric 110. As shown in FIG. 1D, SR dielectric 110 may be formed on the exposed portions of the substrate 102 and close to, but not in contact with, the patterned metal layer 106.

After these steps, a conventional surface finish (SF) process may be performed to place SF metals 112 on the patterned metal layer 106. The SF metals 112 may include nickel/palladium/gold (Ni/Pd/Au) or tin (Sn), for example. The SF metals 112 may be formed by convention techniques such as electroplating, CVD, ALD, or sputtering. With no remaining exposed portions of the seed layer 104, the SF metal 112 may only plate or form on the exposed patterned metal layers 106. This may leave the dielectric surfaces free and clean of any unwanted metals.

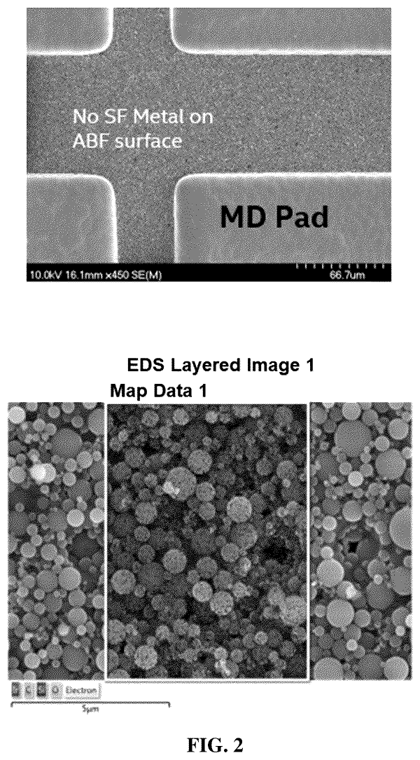

FIG. 2 shows a top down SEM image of a MD pad after the SF process step according to the aspect described above. A low dose excimer beam was used to strip the unwanted palladium seed layer post flash etching. The SEM shows well defined MD pads with no SF metal on the dielectric surfaces of ABF (shown) and SR (not shown). The EDS elemental analysis also confirmed the absence of any SF metals in the dielectric regions away from the MD pads.

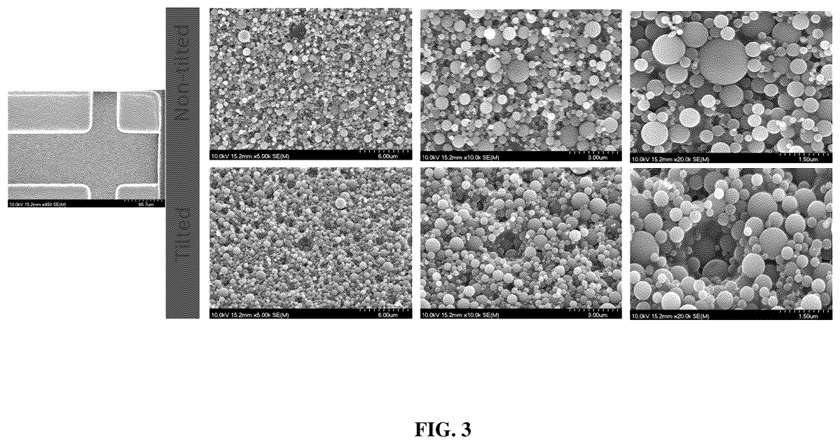

FIG. 3 shows a top down SEM image of a ABF surface after the SF process step according to the aspect described above. At milder doses, the laser beam may ablate a couple of microns of the dielectric surface. In this case, it can be seen locations (white arrows) where the ABF-fillers were removed by either the laser stripping process or the process of record (POR) process. XSEM may also show a slight drop of ABF thickness (˜0.5 μm) away from the MD pad where the excimer beam was applied.

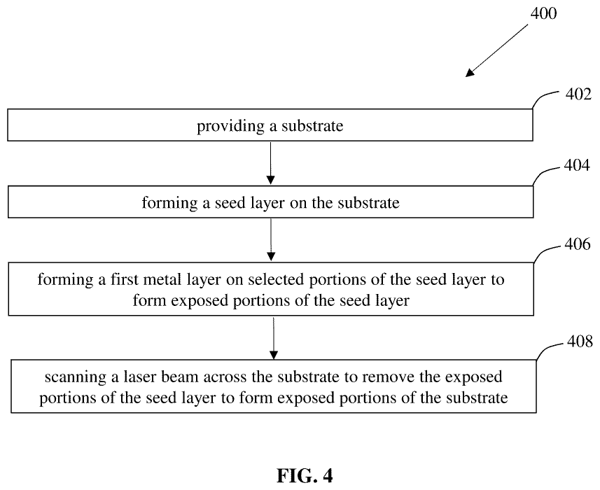

FIG. 4 shows a flow chart illustrating a method 400 of forming an assembly according to an aspect of the present disclosure.

At operation 402, the method 400 may include providing a substrate.

At operation 404, the method 400 may also include forming a seed layer on the substrate.

At operation 406, the method 400 may further include forming a first metal layer on selected portions of the seed layer to form exposed portions of the seed layer.

At operation 408, the method 400 may also further include scanning a laser beam across the substrate to remove the exposed portions of the seed layer to form exposed portions of the substrate.

It will be understood that the above operations described above relating to FIG. 4 are not limited to this particular order. Any suitable, modified order of operations may be used.

### EXAMPLES

Example 1 may include a method. The method may include providing a substrate, forming a seed layer on the substrate, forming a first metal layer on selected portions of the seed layer to form exposed portions of the seed layer, and scanning a laser beam across the substrate to remove the exposed portions of the seed layer to form exposed portions of the substrate.

Example 2 may include the method of example 1 and/or any other example disclosed herein, wherein scanning a laser beam may include scanning a laser beam using an excimer laser, a ultraviolet laser, an infrared laser, or a near-infrared laser.

Example 3 may include the method of example 2 and/or any other example disclosed herein, wherein scanning a laser beam may include scanning a laser beam using an excimer laser.

Example 4 may include the method of example 3 and/or any other example disclosed herein, wherein scanning a laser beam may include scanning a laser beam using an excimer laser at 1 J/cm² or less fluence.

Example 5 may include the method of example 4 and/or any other example disclosed herein, wherein scanning a laser beam may include scanning a laser beam using an excimer laser at 0.3 J/cm² to 0.8 J/cm² fluence.

Example 6 may include the method of example 3 and/or any other example disclosed herein, wherein scanning a laser beam may include scanning a laser beam using an excimer laser at 10 or less pulse per second.

Example 7 may include the method of example 6 and/or any other example disclosed herein, wherein scanning a laser beam may include scanning a laser beam using an excimer laser at 1 to 4 pulse per second.

Example 8 may include the method of example 1 and/or any other example disclosed herein, wherein the seed layer may include palladium (Pd), titanium copper (TiCu), nickel chromium (NiCr), copper (Cu), or chromium (Cr).

Example 9 may include the method of example 1 and/or any other example disclosed herein, wherein the first metal layer may include copper (Cu).

Example 10 may include the method of example 1 and/or any other example disclosed herein, wherein the substrate may include a dielectric Ajinomoto Build-up Film, a solder resist film, or any dielectric film.

Example 11 may include the method of example 1 and/or any other example disclosed herein, further including forming a solder resist layer on selected regions of the exposed portions of the substrate.

Example 12 may include the method of example 11 and/or any other example disclosed herein, further including forming a second metal layer on the first metal layer.

Example 13 may include the method of example 12 and/or any other example disclosed herein, wherein the second metal layer may include nickel/palladium/gold (Ni/Pd/Au) or tin (Sn).

Example 14 may include an assembly. The assembly may include a substrate, a seed layer on the substrate, a first metal layer on selected portions of the seed layer to define exposed portions of the seed layer, wherein the assembly may include exposed portions of the substrate.

Example 15 may include the assembly of any one of examples 1 to 14 disclosed herein, wherein the seed layer may include palladium (Pd), titanium copper (TiCu), nickel chromium (NiCr), copper (Cu), or chromium (Cr).

Example 16 may include the assembly of any one of examples 1 to 15 disclosed herein, wherein the first metal layer may include copper.

Example 17 may include the assembly of any one of examples 1 to 16 disclosed herein, wherein the substrate may include a dielectric Ajinomoto Build-up Film, a solder resist film, or any dielectric film.

Example 18 may include the assembly of any one of examples 1 to 17 disclosed herein, further including a solder resist layer on selected portions of the substrate.

Example 19 may include the assembly of any one of examples 1 to 18 disclosed herein, further including a second metal layer on the first metal layer.

Example 20 may include the assembly of any one of examples 1 to 19 and/or any other example disclosed herein, wherein the second metal layer may include nickel/palladium/gold (Ni/Pd/Au) or tin (Sn).

The term “comprising” shall be understood to have a broad meaning similar to the term “including” and will be understood to imply the inclusion of a stated integer or operation or group of integers or operations but not the exclusion of any other integer or operation or group of integers or operations. This definition also applies to variations on the term “comprising” such as “comprise” and “comprises”.

While the present disclosure has been particularly shown and described with reference to specific aspects, it should be understood by persons skilled in the art that various changes in form and detail may be made therein without departing from the scope of the present disclosure as defined by the appended claims. The scope of the present disclosure is thus indicated by the appended claims and all changes which come within the meaning and range of equivalency of the claims are therefore intended to be embraced.

What is claimed is:

1. A method comprising:
providing a substrate;
forming a seed layer on the substrate;
forming a first metal layer on selected portions of the seed layer to form exposed portions of the seed layer; and
scanning a laser beam across the substrate to remove the exposed portions of the seed layer to form exposed portions of the substrate.

2. The method of claim 1, wherein scanning a laser beam comprises scanning a laser beam using an excimer laser, a ultraviolet laser, an infrared laser, or a near-infrared laser.

3. The method of claim 2, wherein scanning a laser beam comprises scanning a laser beam using an excimer laser.

4. The method of claim 3, wherein scanning a laser beam comprises scanning a laser beam using an excimer laser at 1 J/cm² or less fluence.

5. The method of claim 4, wherein scanning a laser beam comprises scanning a laser beam using an excimer laser at 0.3 J/cm² to 0.8 J/cm² fluence.

6. The method of claim 3, wherein scanning a laser beam comprises scanning a laser beam using an excimer laser at 10 or less pulse per second.

7. The method of claim 6, wherein scanning a laser beam comprises scanning a laser beam using an excimer laser at 1 to 4 pulse per second.

8. The method of claim 1, wherein the seed layer comprises palladium (Pd), titanium copper (TiCu), nickel chromium (NiCr), copper (Cu), or chromium (Cr).

9. The method of claim 1, wherein the first metal layer comprises copper (Cu).

10. The method of claim 1, wherein the substrate comprises a dielectric Ajinomoto Build-up Film, a solder resist film, or any dielectric film.

11. The method of claim 1, further comprising forming a solder resist layer on selected regions of the exposed portions of the substrate.

12. The method of claim 11, further comprising forming a second metal layer on the first metal layer.

13. The method of claim 12, wherein the second metal layer comprises nickel/palladium/gold (Ni/Pd/Au) or tin (Sn).

14. An assembly comprising:
a substrate;
a seed layer on the substrate;
a first metal layer on selected portions of the seed layer to define exposed portions of the seed layer;
wherein the assembly comprises exposed portions of the substrate.

15. The assembly of claim 14, wherein the seed layer comprises palladium (Pd), titanium copper (TiCu), nickel chromium (NiCr), copper (Cu), or chromium (Cr).

16. The assembly of claim 14, wherein the first metal layer comprises copper.

17. The assembly of claim 14, wherein the substrate comprises a dielectric Ajinomoto Build-up Film, a solder resist film, or any dielectric film.

18. The assembly of claim 14, further comprising a solder resist layer on selected portions of the substrate.

19. The assembly of claim 18, further comprising a second metal layer on the first metal layer.

20. The assembly of claim 19, wherein the second metal layer comprises nickel/palladium/gold (Ni/Pd/Au) or tin (Sn).
